(19) United States
(12) Patent Application Publication
(10) Pub. No.: US 2004/0203640 A1
(43) Pub. Date: Oct. 14, 2004

(54) Providing RNC internet protocol address to circuit switched domain

(76) Inventors: Anders Molander, Linkoping (SE); Martin Israelsson, Spanga (SE); Fredrik Aberg, Kyrkslatt (FI)

Correspondence Address: NIXON & VANDERHYE P.C., 1100 North Glebe Road, 8th Floor, Arlington, VA, 22201, US

(21) Appl. No.: 10/141,782

(22) Filed: May 10, 2002

(51) Int. Cl. H04Q 7/20

(52) U.S. Cl. 455/414.1; 455/466

(57) ABSTRACT

Upon receipt of a request message from a core network (CN) relating to a procedure for a radio access bearer, a radio network controller node (26) of a radio access network (RAN) sends to a core network a first message (4-2) which includes, e.g., an Internet Protocol (IP) address of the radio network controller node. Subsequently the radio network controller node sends to the core network a second message (4-4) which indicates an outcome of the procedure. In one example implementation, the procedure for the radio access bearer is one of a RAB establish procedure and a RAB modify procedure. The RAB establish procedure can be initiated by an RAB Assignment Request message and is particularly useful for a RAB Assignment Request message which specifies a support mode. In this example implementation, both the first message and the second message are separate transmissions of a RAB Assignment Response message. Both transmissions of the RAB Assignment Response message preferably have a same format, but with a first transmission of the RAB Assignment Response message including, e.g., an Internet Protocol (IP) address (and, optionally, UDP port) of the radio network controller node.

### BACKGROUND

1. Field of the Invention

The present invention pertains to wireless telecommunications, and particularly to a radio access bearer-related procedure which involves reporting of an Internet Protocol (IP) address of a node which performs the radio access bearer-related procedure.

2. Related Art and Other Considerations

In a typical cellular radio system, wireless user equipment units (UEs) communicate via a radio access network (RAN) to one or more core networks. The user equipment units (UEs) can be mobile stations such as mobile telephones (“cellular” telephones) and laptops with mobile termination, and thus can be, for example, portable, pocket, hand-held, computer-included, or car-mounted mobile devices which communicate voice and/or data with radio access network. Alternatively, the wireless user equipment units can be fixed wireless devices, e.g., fixed cellular devices/terminals which are part of a wireless local loop or the like.

The radio access network (RAN) covers a geographical area which is divided into cell areas, with each cell area being served by a base station. A cell is a geographical area where radio coverage is provided by the radio base station equipment at a base station site. Each cell is identified by a unique identity, which is broadcast in the cell. The base stations communicate over the air interface (e.g., radio frequencies) with the user equipment units (UE) within range of the base stations. In the radio access network, several base stations are typically connected (e.g., by landlines or microwave) to a radio network controller (RNC). The radio network controller, also sometimes termed a base station controller (BSC), supervises and coordinates various activities of the plural base stations connected thereto. The radio network controllers are typically connected to one or more core networks. The core network has various service domains, with an RNC having an interface to these domains.

One example of a radio access network is the Universal Mobile Telecommunications (UMTS) Terrestrial Radio Access Network (UTRAN). The UMTS is a third generation system which in some respects builds upon the radio access technology known as Global System for Mobile communications (GSM) developed in Europe. UTRAN is essentially a radio access network providing wideband code division multiple access (WCDMA) to user equipment units (UEs). The Third Generation Partnership Project (3GPP) has undertaken to evolve further the UTRAN and GSM-based radio access network technologies.

The Universal Mobile Telecommunications (UMTS) Terrestrial Radio Access Network (UTRAN) accommodates both circuit switched and packet switched connections. In this regard, in UTRAN the circuit switched connections involve a radio network controller (RNC) communicating with a mobile switching center (MSC), which in turn is connected to a connection-oriented, external core network, which may be (for example) the Public Switched Telephone Network (PSTN) and/or the Integrated Services Digital Network (ISDN). On the other hand, in UTRAN the packet switched connections involve the radio network controller communicating with a Serving GPRS Support Node (SGSN) which in turn is connected through a backbone network and a Gateway GPRS support node (GGSN) to packet-switched networks (e.g., the Internet, X.25 external networks).

There are several interfaces of interest in the UTRAN. The interface between the radio network controllers (RNCs) and the core network(s) is termed the “Iu” interface. More particularly, the interface between the radio network controllers (RNCs) and circuit switched (CS) core networks is often referred to as the “Iu-cs” interface, while the interface between the radio network controllers (RNCs) and packet switched (PS) core networks is sometimes referred to as the “Iu-ps” interface. The interface between a radio network controller (RNC) and its base stations (BSs) is termed the “Iub” interface. The interface between the user equipment unit (UE) and the base stations is known as the “air interface” or the “radio interface” or “Uu interface”. In some instances, a connection involves both a Serving RNC (SRNC) and a drift RNC (DRNC), with the SRNC controlling the connection but with one or more diversity legs of the connection being handling by the DRNC. An Inter-RNC transport link can be utilized for the transport of control and data signals between Serving RNC and a Drift RNC. An interface between radio network controllers (e.g., between a Serving RNC [SRNC] and a Drift RNC [DRNC]) is termed the “Iur” interface.

The radio network controller (RNC) controls the UTRAN. In fulfilling its control role, the RNC manages resources of the UTRAN. Such resources managed by the RNC include (among others) the downlink (DL) power transmitted by the base stations; the uplink (UL) interference perceived by the base stations; and the hardware situated at the base stations.

The UTRAN interfaces (Iu, Iur and Iub) have two planes, namely, a control plane (CP) and a user plane (UP). In order to control the UTRAN, the radio network application in the different nodes communicate by using the control plane protocols. The RANAP is a control plane protocol for the Iu interface; the RNSAP is a control plane protocol for the Iur interface; and NBAP is a control plane protocol for the lub interface.

A UMTS Terrestrial Radio Access Network (UTRAN) responds to radio access service requests by allocating resources needed to support a communication with a UE. A procedure for establishing a radio access bearer is described in 3GPP TS 25.931. As mentioned above, the UTRAN includes plural base stations for communicating with UEs over the radio air interface using radio channel resources allocated by a radio network controller connected to the base stations. External network service nodes (that interface with external networks) communicate with UEs via the UTRAN. When one of the service nodes requires communication with a UE, the service node requests a radio access “bearer” (RAB) from the UTRAN rather than a specific radio channel resource.

A radio access bearer (RAB) is a logical connection with the UE through the UTRAN and over the radio air interface and corresponds to a single data stream. For example, one radio access bearer may support a speech connection, another bearer may support a video connection, and a third bearer may support a data packet connection. Each radio access bearer is associated with quality of service (QoS) parameters describing how the UTRAN should handle the data stream. Although the term “radio access bearer” is sometimes used for purposes of the following description, the invention applies to any type of “connection,” and is not limited to logical connections like RABs, a particular type of physical connection, etc.

Radio access bearers are dynamically assigned to UTRAN transport and radio channel resources by the UTRAN. The radio access bearer service and the UTRAN isolate the details of transport and radio resource allocation handling as well as details of radio control, e.g., soft handoff. The UTRAN approach is different from traditional approaches where an external network and/or an external network service node is involved in the details of requesting, allocating, and controlling specific radio connections to and from the mobile radio. Instead, the external network service node only needs to request a radio access bearer service over a RAN interface to the UTRAN along with a specific quality of service for a communication to a specific mobile radio. The UTRAN provides the requested service at the requested quality of service (if possible).

To initiate a radio access bearer service, a request is transmitted to the UTRAN for communication with a UE. One or more parameters accompany the radio access bearer service request. When establishing each bearer, the UTRAN “maps” or allocates the radio access bearer to physical transport and radio channel resources through the UTRAN and over the radio air interface, respectively. The mapping is based on one or more parameters associated with the radio access bearer service request. In addition to quality of service parameters, the parameters may also include one or more traffic condition parameters like a congestion level on a common channel, an interference level in the geographic location area in which the UE is currently operating, a distance between the UE and the base station, radio transmit power, the availability of dedicated channel resources, the existence of a dedicated channel to a UE, and other traffic parameters or conditions. See, e.g., U.S. patent application Ser. No. 09/778,960, entitled “METHOD AND APPARATUS FOR RELEASING CONNECTIONS IN AN ACCESS NETWORK”, which is incorporated by reference herein in its entirety.

More specifically, when a core network initiates a radio access bearer service, the core network issues a RAB Assignment Request message. This RAB Assignment Request message includes an information element (IE) which specifies whether the User Plane Mode is “transparent mode” or “support mode”.

The transparent mode (TrM) is intended for those RABs that do not require any particular feature from the Iu UP protocol other than the transfer of user data. In the Transparent Mode, the Iu UP protocol instance does not perform any Iu UP protocol information exchange with its peer over the Iu interface (e.g., no Iu frame is sent). The Iu UP protocol layer is crossed through by PDUs being exchanged between upper layers and the network transport layer.

The support mode, on the other hand, is intended for those radio access bearers that do require particular features from the Iu UP protocol in addition to transfer of user data. When operating in the support mode, the peer Iu UP protocol instances exchange Iu UP frames (whereas, in the transparent mode no Iu UP frames are generated). Some radio access bearers which request the Iu UP protocol support actually constrain the Iu UP protocol and possibly the radio interface protocol in specific ways. For instance, certain radio access bearers can have variable predefined rates. In essence, the Iu UP support mode is intended to support such variations.

In accordance with conventional practice, upon receipt of the RAB Assignment Request message, a determination is made whether sufficient resources exist in the radio network controller or at the node B to provide the requested radio access bearer. Lack of sufficient resources requires a wait to determine if sufficient resources will soon become available. In order to prevent a timeout at the core network node CN during this waiting period, a message is sent to the core network node CN to advise that the RAB request is being queued at the radio network controller pending availability of the requisite resources. Later, when resources become available, a second message advises the core network node of the outcome of the RAB procedure (e.g., whether the RAB was successfully established or not).

A user plane initialization procedure is necessary for radio access bearers which use the support mode for predefined SDU size. The user plane initialization procedure serves to configure both termination points of the Iu UP with RAB subflow combinations, RFCIs, and associated RAB subflow SDU sizes and eventual inter PDU timing intervals necessary to be supported during the transfer of the user data phase. In essence, the user plane initialization procedure involves definition of a mapping between RFCIs and PDU sizes and eventual inter PDU timing intervals and transfer of the mapping to the Iu UP peer entity. In the user plane initialization procedure, the RNC sends an initialization control frame or report message to the core network. The initialization control frame includes RFCIs and SDU sizes. Receipt of the initialization control frame is then acknowledged by the core network. The user plane modes and user plane initialization are described in more detail in 3GPP TS 25.415.

Once a specific radio access bearer has been established or modified at the request of a core network node, the successful establishment or modification of the radio access bearer must be reported to the core network node. However, in the case that the RAB Assignment message indicates by its User Plane Mode information element that the support mode is applicable (i.e., the support mode for predefined SDU sizes) or during modification of an existing support mode RAB, the RANAP specification (e.g., 3GPP TS 25.413 V5.0.0) requires that the RNC node first perform the user plane initialization procedure (described, e.g., in the preceding paragraph) before the successful establishment or modification of the radio access bearer can be reported to the core network.

In implementing a TNL (Transport Network Layer) based on the Internet Protocol (IP) for the Iu interface, it has heretofore been assumed that the Internet Protocol address of the RNC involved in establishing a radio access bearer is sent to the core network in a RAB Assignment Response message indicating the establishment of the radio access bearer (after the core network has sent a RAB Assignment Request message requesting that the radio access bearer be established). But the foregoing requirement imposed by RANAP for the user plane support mode, i.e., that the RNC node first perform user plane initialization for the support mode before reporting successful establishment of the radio access bearer, poses a problem to this assumption with respect to the support mode. For example, if the user plane initialization is performed and reported to the core network prior to receipt by the core network of the RNC IP address-bearing RAB Assignment message, the core network does not have an address as to where the core network should send a message which acknowledges that the user plane initialization report message (e.g., the initialization control frame) has been received. In essence this means that, under existing protocol constraints, the RANAP requirements cannot be met since the user plane cannot be initialized for the support mode before the RAB Assignment Response message is sent to the core network.

Various proposed strategies have been propounded for attempting to communicate the RNC IP address to the core network in timely fashion in conjunction with establishing an RAB when the support mode is requested in the RAB Assignment procedure on the Iu-cs interface.

A first such proposed strategy is to let a media gate way (MGW) extract the source IP address from an IP header of a frame of information known as the initialization frame. A pronounced drawback of this first proposal is that there would be a difference between transparent mode and support mode for Iu-cs, since for transparent mode the RNC IP address would be included in the RAB ASSIGNMENT RESPONSE message but for the support mode it would be included in the IP header of the initialization frame. Other disadvantages include (1) additional delay (compared to the AAL2/ATM case) before the MGW receives the IP address of the RNC; and (2) additional security issues.

A second proposed strategy is to include the RNC IP address (and the UDP port) in the initialization control frame of the Iu frame protocol. In addition to the disadvantages above mentioned for the first proposed strategy, this second proposed strategy would require a TNL (Transport Network Layer) dependant parameter in the RNL (Radio Network Layer), because the IP address would only be included in the frame protocol for the IP option. There would also be a difference between transparent mode and support mode for CS, since for transparent mode the RNC IP address would be included in the RAB ASSIGNMENT RESPONSE message but for the support mode it would be included in the frame protocol.

A third proposed strategy is to initialize the user plane from the MGW after the RAB Assignment Response has been received by the core network. If this were allowed, the IP address and UDP port of the RNC could be included in the RAB Assignment Response and there would be the same behavior for both Iu UP modes of operation. In this strategy the MGW will also know when the Iu bearer is ready for transfer of user data. But this third proposed strategy requires some revamping of the Iu-cs which, although not large, may result in new behavior depending on the TNL option and user plane mode.

A fourth proposed strategy is to initialize the Iu-cs user plane after the RAB Assignment Response has been received by the core network. In other words, if the RANAP requirements mentioned above were to be changed to allow the RNC to send the RAB Assignment Response message before the Iu user plane RNL is ready to be used, the RNC could send the initialization frame to the MGW. Moreover, before the initialization acknowledgement is received, the RNC could reply to the core network (e.g., MSC server) with the RAB Assignment Response message. The core network sends the IP address and UDP port of the RNC to the MGW, and then the MGW sends the initialization acknowledgement back to the RNC. This fourth proposal involves more sophistication at the servers of the RNC and core network nodes, as well as a new procedure between the core network and the MGW in order to convey the IP address and UDP port of the RNC. Other drawbacks attending this fourth proposal include disadvantages (1)-(2) above listed for the first proposed strategy, as well as (3) a requirement for additional error handling; and (4) the core network not knowing if the establishment of the radio access bearer has succeeded (the meaning of the RAB Assignment Response message would depend on the particular 3GPP release implemented in the RNC).

A fifth proposed strategy is to use an Access Link Control Application Protocol (ALCAP) for the IP TNL on the Iu-cs, e.g., to exchange the IP addresses and UDP ports on the Iu-cs. Access Link Control Application Protocol (ALCAP) is a generic name for transport signaling protocols which are used to set up and tear down transport bearers. But the introduction of a mandatory ALCAP in Re15 IP-IP based Iu-cs would violate two agreed objectives of the IP transport Work Item (which enables usage of IP technology for the transport of signaling and user data over the Iu, the Iur and the Iub interfaces in the UTRAN). The first one is the objective of getting rid of any mandatory ALCAP protocol and the second one is the objective of harmonizing the Iu-cs with the Iu-ps interface.

What is needed, therefore, and an object of the present invention, is an effective and harmonious technique for providing a RNC IP address to a circuit switch core network in conjunction with establishment or modification of a radio access bearer.

### BRIEF SUMMARY

Upon receipt of a request message from a core network relating to a procedure for a radio access bearer, a radio network controller node of a radio access network (RAN) sends to a core network a first message which includes, e.g., an Internet Protocol (IP) address of the radio network controller node. Subsequently the radio network controller node sends to the core network a second message which indicates an outcome of the procedure.

In one example implementation, the procedure for the radio access bearer is one of a RAB establish procedure and a RAB modify procedure. The RAB establish procedure can be initiated by an RAB Assignment Request message and is particularly useful for a RAB Assignment Request message which specifies a support mode. In this example implementation, both the first message and the second message are separate transmissions of a RAB Assignment Response message. Both transmissions of the RAB Assignment Response message preferably have a same format, but with a first transmission of the RAB Assignment Response message including, e.g., an Internet Protocol (IP) address (and, preferably, UDP port) of the radio network controller node.

In an example implementation, the first transmission of the RAB Assignment Response message occurs in conjunction with queuing of the RAB and includes, in addition to the Internet Protocol (IP) address of the radio network controller node, information regarding the queuing of the radio access bearer (e.g., confirming that the radio access bearer is being queued). The second transmission of the RAB Assignment Response message reports an outcome of the RAB procedure to the core network (e.g., establishment or failure of the RAB procedure).

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1A is diagrammatic view of first example mobile communications system in which the present invention may be advantageously employed.

FIG. 1B is diagrammatic view of second example mobile communications system in which the present invention may be advantageously employed.

FIG. 2 is a simplified function block diagram of a portion of a UMTS Terrestrial Radio Access Network, including a user equipment unit (UE) station; a radio network controller; and a base station.

FIG. 3 is a schematic view of an example RNC node in accordance with one embodiment of the invention.

FIG. 4 is a diagrammatic view showing, e.g., certain events performed and messages transmitted in conjunction with a RAB procedure.

FIG. 5 is a diagrammatic view of certain basic example actions included in a RAB procedure.

### DETAILED DESCRIPTION OF THE DRAWINGS

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well-known devices, circuits, and methods are omitted so as not to obscure the description of the present invention with unnecessary detail. Moreover, individual function blocks are shown in some of the figures.

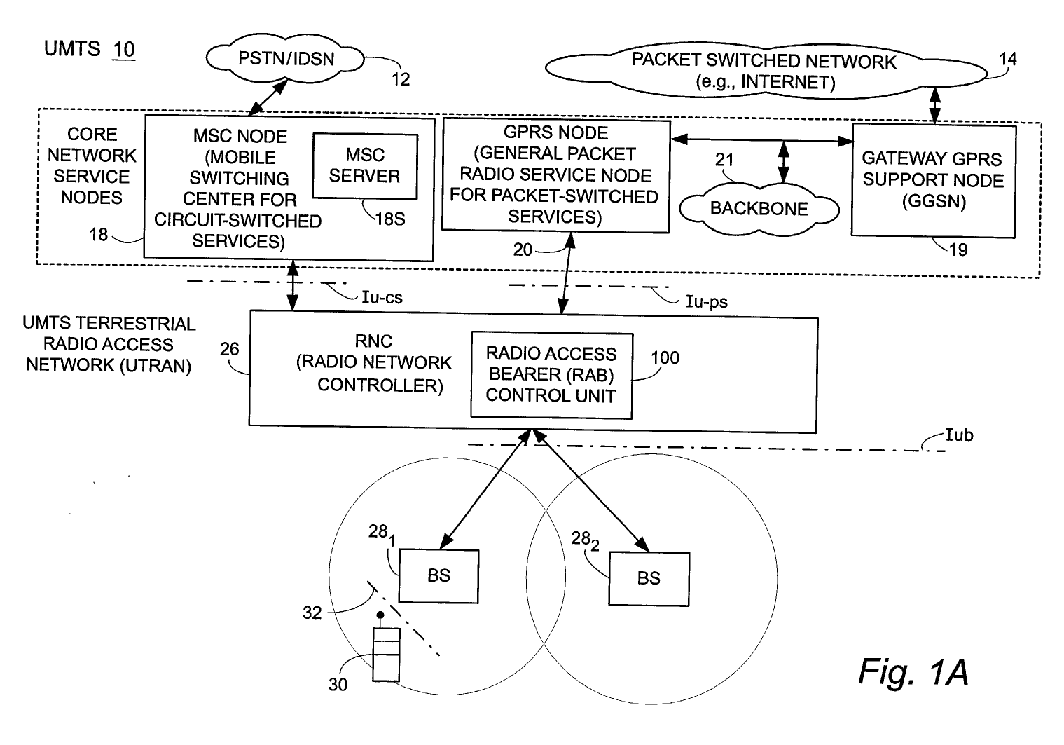

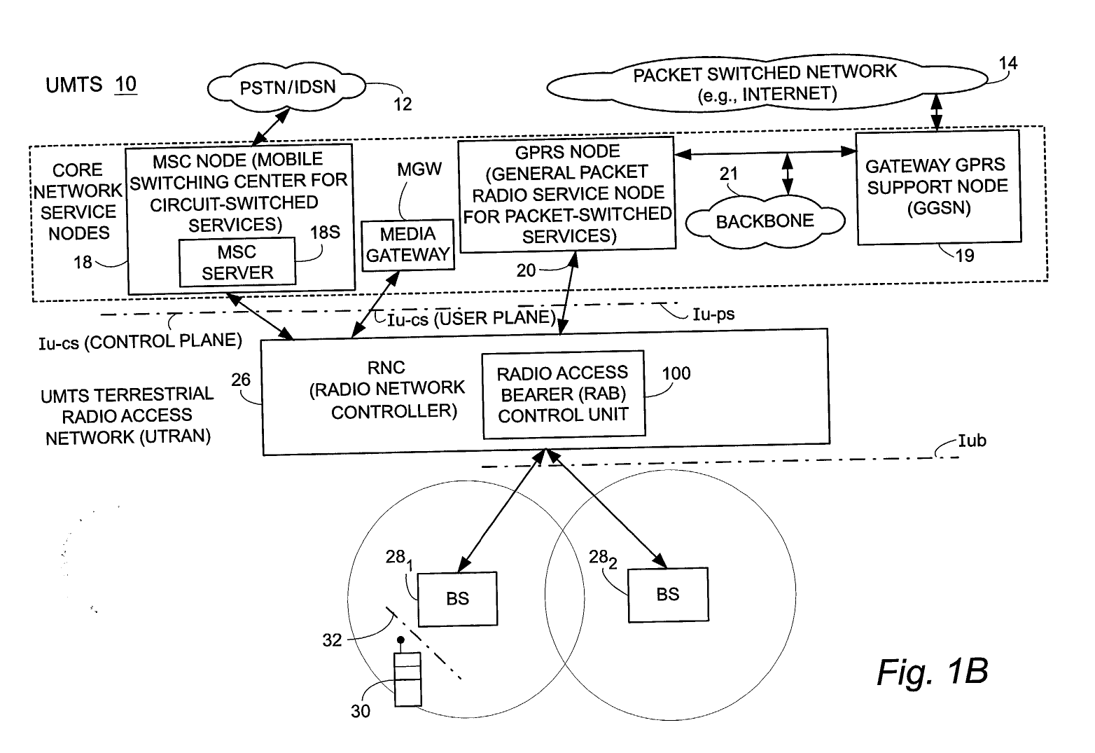

The present invention is described in the non-limiting, example context of two alternative universal mobile telecommunications networks (UMTS) 10 shown in FIG. 1A and FIG. 1B. A representative, connection-oriented, external core network, shown as a cloud 12 may be for example the Public Switched Telephone Network (PSTN) and/or the Integrated Services Digital Network (ISDN). A representative, connectionless external core network shown as a cloud 14, may be for example the Internet. Both core networks are coupled to their corresponding service nodes.

In an illustrative, example context, as shown in FIG. 1A the PSTN/ISDN connection-oriented network 12 is connected to a connection-oriented service node (core network node) shown as a Mobile Services Switching Center (MSC) node 18 that provides circuit-switched services. The Mobile Services Switching Center (MSC) node 18 has a MSC server 18S.

Also by way of example, the Internet connectionless-oriented network 14 is connected through a Gateway General Packet Radio Service (GPRS) support node (GGSN) 19 to a General Packet Radio Service (GPRS) Service (SGSN) node 20, the latter being tailored to provide packet-switched type services. Gateway GRPS support node (GGSN) 19 provides the interface towards the packet-switched networks (e.g., the Internet, X.25 external networks) represented by cloud 14. Gateway GRPS support node (GGSN) 19 translates data formats, signaling protocols and address information in order to permit communication between the different networks. Serving GPRS Support Node (SGSN) 20 provides packet routing to and from a SGSN service area, and serves GPRS subscribers which are physically located within the SGSN service area. Serving GPRS Support Node (SGSN) 20 provides functions such as authentication, ciphering, mobility management, charging data, and logical link management toward the user equipment unit. A GPRS subscriber may be served by any SGSN in the network depending on location. The functionality of Serving GPRS Support Node (SGSN) 20 and Gateway GRPS support node (GGSN) 19 may be combined in the same node, or may exist in separate nodes as shown in FIG. 1A and FIG. 1B. Backbone network 21 provides connection between different GSN nodes and other components of the core network, and can be, e.g., an Internet Protocol (IP) network.

Each of the core network service nodes 18 and 20 connects to a UMTS Terrestrial Radio Access Network (UTRAN) 24 over a radio access network (RAN) interface referred to as the Iu interface. UTRAN 24 includes one or more radio network controllers (RNCs) 26. The interface between the radio network controllers (RNCs) and circuit switched (CS) core networks is often referred to as the “Iu-cs” interface, while the interface between the radio network controllers (RNCs) and packet switched (PS) core networks is sometimes referred to as the “Iu-ps” interface.

As an alternative, FIG. 1B shows the split circuit switched (cs) core network where the Mobile Services Switching Center (MSC) node 18 has been split into one MSC-server part and one Media Gateway (MGW) part. The MSC-server part terminates the Iu-cs control plane, and the media gateway MGW (or MG) terminates the Iu-cs user plane. As used hereinafter, with reference to the Iu-cs interface, reference to a core network node can refer to any appropriate core network node, such as to the MSC node 18 in the case of FIG. 1A or the media gateway node MGW in the case of FIG. 1B.

The radio network controllers (RNCs) 26 serve one or more base stations (BS) 28. For sake of simplicity, the UTRAN 24 of FIG. 1A and FIG. 1B is shown with only one RNC node, particularly RNC 26 which is connected to one or more base stations (BS) 28. For example, and again for sake of simplicity, two base station nodes are shown connected to RNC 26. In this regard, RNC 26 serves base station 28₁ and base station 28₂. It will be appreciated that a different number of base stations can be served by an RNC, and that RNCs need not serve the same number of base stations. Those skilled in the art will also appreciate that a base station is sometimes also referred to in the art as a radio base station, a node B, or B-node.

In the illustrated embodiments, for sake of simplicity each base station 28 is shown as serving one cell. Each cell is represented by a circle which surrounds the respective base station. It will be appreciated by those skilled in the art, however, that a base station may serve for communicating across the air interface for more than one cell. For example, two cells may utilize resources situated at the same base station site.

A user equipment unit (UE), such as user equipment unit (UE) 30 shown in FIG. 1A and FIG. 1B, communicates with one or more cells or one or more base stations (BS) 28 over a radio or air interface 32. Each of the radio interface 32, the Iu interface, and the Iub interface are shown by dash-dotted lines in FIG. 1A and FIG. 1B.

Preferably, radio access is based upon Wideband, Code Division Multiple Access (WCDMA) with individual radio channels allocated using CDMA spreading codes. Of course, other access methods may be employed. WCDMA provides wide bandwidth for multimedia services and other high transmission rate demands as well as robust features like diversity handoff and RAKE receivers to ensure high quality.

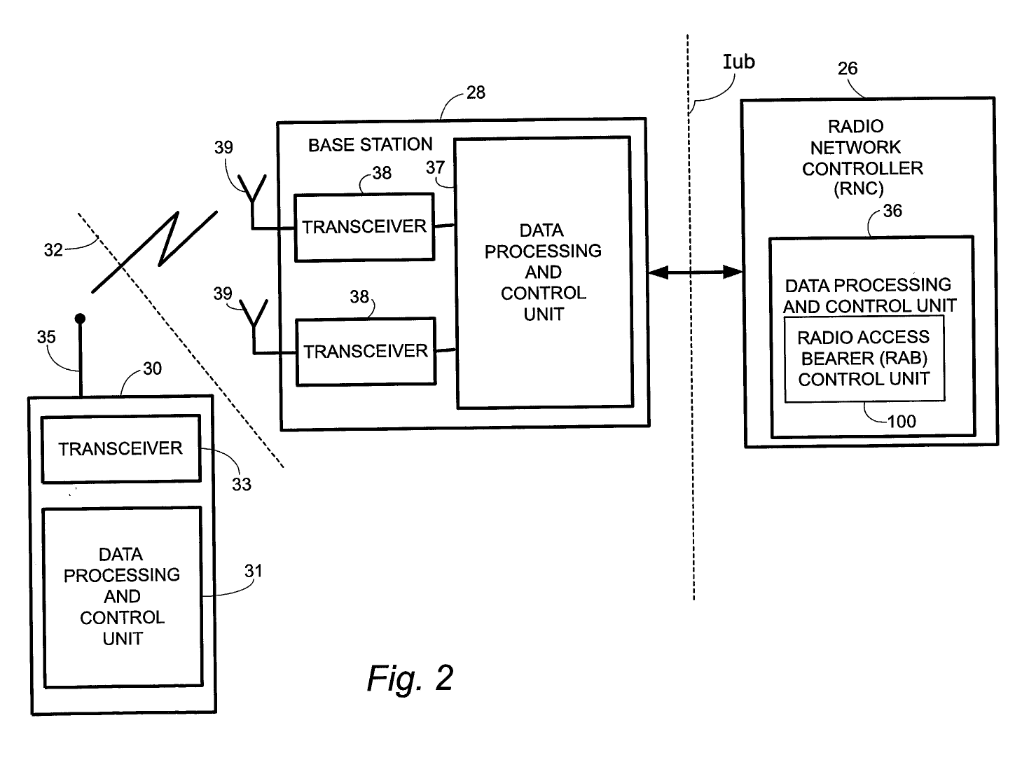

FIG. 2 shows selected general aspects of user equipment unit (UE) 30 and illustrative nodes such as radio network controller 26 and base station 28. The user equipment unit (UE) 30 shown in FIG. 2 includes a data processing and control unit 31 for controlling various operations required by the user equipment unit (UE). The UE's data processing and control unit 31 provides control signals as well as data to a radio transceiver 33 connected to an antenna 35.

The example radio network controller 26 and base station 28 as shown in FIG. 2 are radio network nodes that each include a corresponding data processing and control unit 36 and 37, respectively, for performing numerous radio and data processing operations required to conduct communications between the RNC 26 and the user equipment units (UEs) 30. Part of the equipment controlled by the base station data processing and control unit 37 includes plural radio transceivers 38 connected to one or more antennas 39.

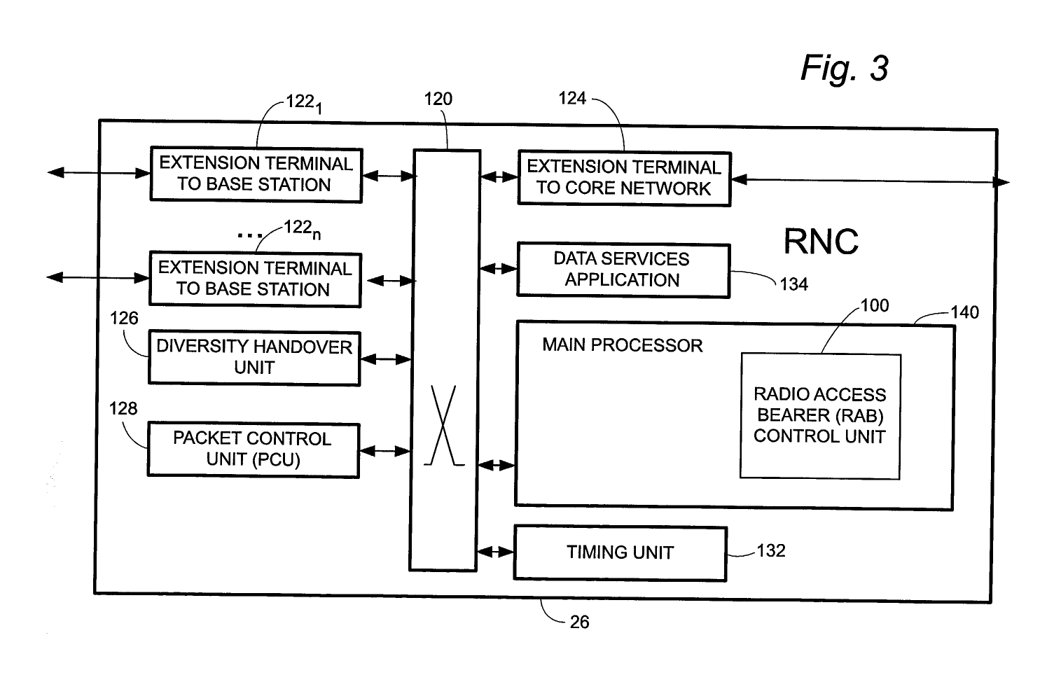

FIG. 3 illustrates, in somewhat more detail, an example non-limiting RNC node 26 of the present invention. It so happens that the RNC node 26 of FIG. 3 is a switched-based node having a switch 120. The switch 120 serves to interconnect other constituent elements of RNC node 26. Such other constituent elements include extension terminals 122₁ through 122ₙ, as well as extension terminal 124. Extension terminals 122₁ through 122ₙ essentially function to connect RNC node 26 to the base stations 28 served by RNC node 26; extension terminal 124 connects RNC node 26 across the Iu interface to the core network.

Yet other constituent elements of RNC node 26 include diversity handover unit 126; an packet control unit (PCU) 128; timing unit 132; a data services application unit 134; and, a main processor 140. The person skilled in the art will appreciate generally the functions of these constituent elements, it being noted that the packet control unit (PCU) 128 provides, e.g., for separation of packet data and circuit-switched data when it is received from the mobile station (user equipment unit (UE)) and multiplexes the different data streams from circuit-switched and packet-switched core networks onto common streams going down to the cells. The PCU can alternatively be located physically separate from the RNC.

FIG. 1A, FIG. 1B, FIG. 2, and FIG. 3 show an example radio access bearer (RAB) control unit 100, also known as a RAB procedure performing unit 100, which is situated at the radio network controller (RNC) 26 and which performs a radio access bearer-related procedure. As one non-limiting implementation, the radio access bearer (RAB) control unit 100 is realized as at least a portion of data processing and control unit 36 of radio network controller (RNC) 26. Those skilled in the art will appreciate that the functions of radio access bearer (RAB) control unit 100 may be implemented in various ways, e.g., using individual hardware circuits, using software functioning in conjunction with a suitably programmed digital microprocessor or general purpose computer, using an application specific integrated circuit (ASIC), and/or using one or more digital signal processors (DSPs).

For sake of illustration, an example procedure for the radio access bearer is a RAB establish procedure. It will be understood that principles herein described are also applicable to other types of RAB procedures, such as a RAB modify procedure, for example.

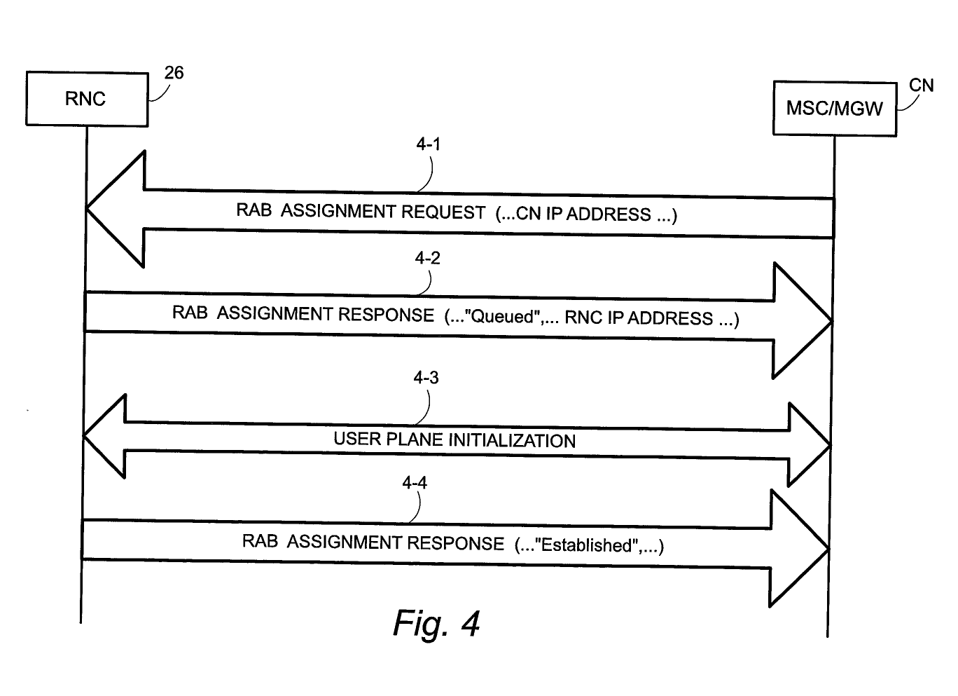

Certain messages and actions relevant to both the RAB procedure performed by radio access bearer (RAB) control unit 100 and the reporting of the IP address of radio network controller (RNC) 26 are illustrated in FIG. 4.

In an example sequence of events shown in FIG. 4, event 4-1 of FIG. 4 depicts transmission of a RAB Assignment Request message from a core network node CN to the radio network controller (RNC) 26. The RAB Assignment Request message includes, e.g., the Internet Protocol (IP) address (and, preferably, UDP port) of the core network node CN. In the illustration provided in FIG. 4, the RAB Assignment Request message also includes an information element for the User Plane Mode, and specifies that the support mode is invoked for the particular RAB requested.

Upon receipt of the RAB Assignment Request message of event 4-1, the radio access bearer (RAB) control unit 100 begins its RAB procedure. Since the RAB Assignment Request message of event 4-1 pertains to a support mode, the radio network controller (RNC) 26 also realizes that a user plane initialization procedure will have to be performed. In view of the requirement of performing the user plane initialization procedure, the radio access bearer (RAB) control unit 100 queues the RAB requested in the RAB Assignment Request message of event 4-1. Then, in conjunction with the queuing, the 100 transmits a first RAB Assignment Response message to the core network node CN to advise that the RAB request is being queued at the radio network controller (RNC) 26. Transmission of the first RAB Assignment Response message is shown as event 4-2 in FIG. 4.

Thus, in accordance with one aspect of the present invention, the radio access bearer (RAB) control unit 100 sends the first RAB Assignment Response message (e.g., of event 4-2) to the core network node CN in conjunction with every received RAB Assignment Request message relating to the use of the support mode, not just for RAB Assignment Request messages in which resources are lacking or queuing necessary. Further, the radio access bearer (RAB) control unit 100 includes in the first RAB Assignment Response message of event 4-2 the IP Address of radio network controller (RNC) 26. Preferably, the first RAB Assignment Response message of event 4-2 also includes the UDP port number of radio network controller (RNC) 26.

After transmission of the first RAB Assignment Request message (which includes, e.g., the IP address of radio network controller (RNC) 26), the user plane initialization procedure is performed as indicated by event 4-3 in FIG. 4. As indicated previously, the user plane initialization procedure involves configuring of both termination points of the Iu UP with RAB subflow combinations, RFCIs, and associated RAB subflow SDU sizes and eventual inter PDU timing intervals necessary to be supported during the transfer of the user data phase, and results in the radio network controller (RNC) 26 sending an initialization control frame or report message to the core network and acknowledgement of receipt of the same by the core network.

The execution of the RAB procedure for the requested RAB continues after, or in parallel with, the performance of the user plane initialization procedure. When the execution of the RAB procedure is completed by radio access bearer (RAB) control unit 100, the radio access bearer (RAB) control unit 100 sends to the core network node CN a second RAB Assignment Response message (depicted by event 4-4). The second RAB Assignment Response message advises the core network node of the outcome of the RAB procedure (e.g., whether the RAB was successfully established or whether the attempt to establish the RAB met with failure).

Preferably both the first RAB Assignment Response message and the second RAB Assignment Response message have a same or common format. A non-limiting example format for the RAB Assignment Response messages is shown in Table 1.

The example format of the RAB Assignment Response message shown in Table 1 includes a RABs Queued List, which has entries for each of a maximum number of RABs (maxnoofRABs) being queued by radio access bearer (RAB) control unit 100. For each RAB referenced in the RABs Queued List, a trilogy of information elements are provided: the RAB ID, the transport layer address, and the Iu transport association. The RAB ID is generated by the core network and is included in the RAB Assignment Request message (e.g., event 4-1) sent from the core network node CN to radio network controller (RNC) 26. The transport layer address is the Internet Protocol (IP) address of radio network controller (RNC) 26. The Iu transport association is the UDP port number of radio network controller (RNC) 26.

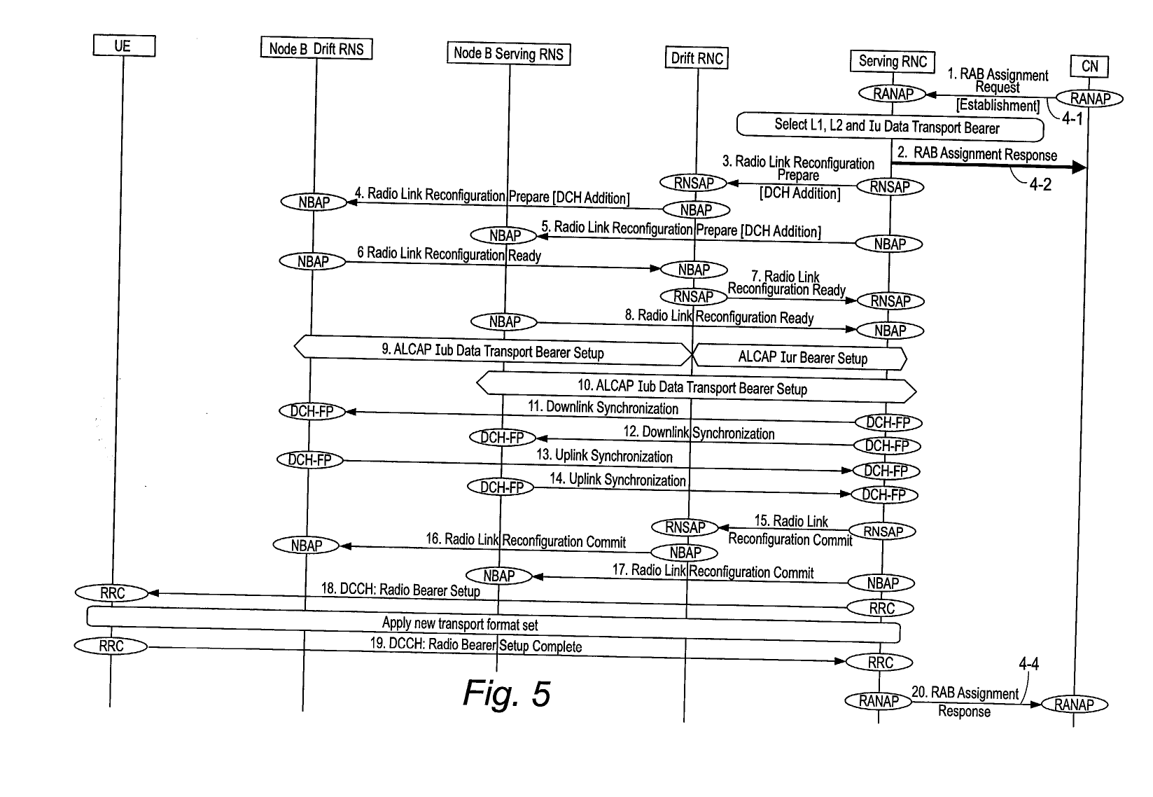

Example steps or events performed in conjunction with the RAB procedure are illustrated in FIG. 5. FIG. 5 explicitly shows receipt of the RAB Assignment Request message of event 4-1. In addition, FIG. 5 shows that the first RAB Assignment Response message of event 4-2 can be sent, for example, at a time subsequent to selection of the L1, L2, and Iu data transport bearers, and before radio link reconfiguration preparation. Also shown in FIG. 5 is the second RAB Assignment Response message of event 4-5 which reflects completion (e.g., RAB establishment) of the RAB procedure.

The RAB procedure described above with transmission of the first RAB Assignment Response message as including the IP address of the radio network controller (RNC) 26 is advantageous in many respects. For example, agreements made during the work with the IP transport work item are fulfilled, including avoidance of any usage of ALCAP protocol and harmonization of the Iu-cs interface and the Iu-ps interface, since no ALCAP is required and the exchange of IP addresses over the Iu-cs interface is accomplished on the RANAP level for both the core network node address and the RNC address as is the case for the Iu-ps interface.

The meaning of the (second) RAB Assignment Response message which indicates whether the radio access bearer is established or failed also remains the same and is independent of the TNL transport option utilized.

Thus, with the present invention, when the user plane mode is support mode for predefined SDU sizes, two RAB Assignment Response messages are sent (as described above with reference to events 4-2 and 4-4 of FIG. 4). For the transparent mode, on the other hand, only one RAB Assignment Response message necessarily need be sent (as in the packet switched case).

The foregoing thus describes a way of exchanging IP addresses (and preferably UDP ports as well) between the core network and the radio network controller that is consistent with the IP Transport Work Item. It makes use of an already-defined RAB queuing function to transfer an RNC IP address to the circuit switched core network and that maintains the current meaning of the RAB Assignment Response message, indicating established (or failed) radio access bearers, thus avoiding the need to define additional error handling procedures.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

TABLE 1

| | Pre- | | IE type and | Semantics | | Assigned |
|---|---|---|---|---|---|---|
| IE/Group Name | sence | Range | reference | description | Critically | Critically |
| Message Type | M | | 9.2.1.1 | | YES | reject |
| RABs Setup Or Modified List | O | | | | YES | ignore |
| >RABs Setup Or Modified | | 1 to | | | EACH | ignore |
| Items les | | <maxnoofRABs> | | | | |
| >>RAB ID | M | | 9.2.1.2 | The same RAB | — | |
| | | | | ID must only be | | |
| | | | | present in one | | |
| | | | | group. | | |
| >>Transport Layer | O | | 9.2.2.1 | | — | |
| Address | | | | | | |
| >>Iu Transport | O | | 9.2.2.2 | | | |
| Association | | | | | | |
| >>DL Data Volumes | O | | | | — | |
| >>>Data Volume List | | 1 to | | | — | |
| | | <maxnoofVol> | | | | |
| >>>>Unsuccessfully | M | | 9.2.3.12 | | — | |
| Transmitted DL Data | | | | | | |
| Volume | | | | | | |
| >>>>Data Volume | O | | 9.2.3.13 | | — | |
| Reference | | | | | | |
| >>Assigned RAB | O | | 9.2.1.44 | | YES | ignore |
| Parameter Values | | | | | | |
| RABs Released List | O | | | | YES | ignore |
| >RABs Released Item IEs | | 1 to | | | EACH | ignore |
| | | <maxnoofRABs> | | | | |
| >>RAB ID | M | | 9.2.1.2 | The same RAB | — | |
| | | | | ID must only be | | |
| | | | | present in one | | |
| | | | | group. | | |
| >>DL Data Volumes | O | | | | — | |
| >>>Data olume List | | 1 to | | | — | |
| | | <maxnoofVol> | | | | |
| >>>>Unsuccessfully | M | | 9.2.3.12 | | — | |
| Transmitted DL Data | | | | | | |
| Volume | | | | | | |
| >>>>Data Volume | O | | 9.2.3.13 | | — | |
| Reference | | | | | | |
| >>DL GTP-PDU | O | | 9.2.2.3 | | — | |
| Sequence Number | | | | | | |
| >>IL GTP-PDU | | | 9.2.2.4 | | — | |
| Sequence Number | | | | | | |
| RABs Queued List | O | | | | YES | ignore |
| >RABs Queued Item IEs | | 1 to | | | EACH | ignore |
| | | <maxnoofRABs> | | | | |
| >>RAB ID | M | | 9.2.1.2 | The same RAB | — | |
| | | | | ID must only be | | |
| | | | | present in one | | |
| | | | | group. | | |
| >>Transport Layer | O | | 9.2.2.1 | | — | |
| Address | | | | | | |
| >>Iu Transport | O | | 9.2.2.2 | | — | |
| Association | | | | | | |
| RABs Failed To Setup Or | O | | | | YES | ignore |
| Modify List | | | | | | |
| >RABs Failed To Setup | | 1 to | | | EACH | ignore |
| Or Modify Item IEs | | <maxnoofRABs> | | | | |
| >>RAB ID | M | | 9.2.1.2 | The same RAB | — | |
| | | | | ID must only be | | |
| | | | | present in one | | |
| | | | | group. | | |
| >>Cause | M | | 9.2.1.4 | | — | |
| RABs Failed To Release List | O | | | | YES | ignore |
| >RABs Failed To Release | | 1 to | | | EACH | ignore |
| Item IEs | | <maxnoofRABs> | | | | |
| >>RAB ID | M | | 9.2.1.2 | The same RAB | — | |
| | | | | ID must only be | | |
| | | | | present in one | | |
| | | | | group. | | |
| >>Cause | M | | 9.2.1.4. | | — | |
| Critically Diagnostics | O | | 9.2.1.35 | | YES | ignore |

What is claimed is:

1. A method of operating a radio network controller node comprising:
upon receipt of a request message relating to a procedure for a radio access bearer, sending from the radio network controller node a first message which includes an Internet Protocol (IP) address of the radio network controller node;
sending from the radio network controller node a second message which indicates an outcome of the procedure.

2. The method of claim 1, wherein the procedure is one of a RAB establish procedure and a RAB modify procedure.

3. The method of claim 1, wherein the request message is a RAB Assignment Request message.

4. The method of claim 1, wherein the request message is a RAB Assignment Request message, and wherein a user plane mode information element in the RAB Assignment Request message specifies a support mode.

5. The method of claim 1, wherein the request message is a RAB Assignment Request message, and wherein the procedure is a RAB modify procedure for a RAB already using a user plane support mode.

6. The method of claim 1, wherein the first message is a RAB Assignment Response message.

7. The method of claim 1, wherein the second message is a RAB Assignment Response message.

8. The method of claim 1, wherein both the first message and the second message are RAB Assignment Response messages having a same format.

9. The method of claim 1, further comprising sending the first message and the second message to a core network node.

10. The method of claim 1, further comprising sending the first message and the second message to a core network node which issued the request message.

11. The method of claim 1, wherein the first message further includes information regarding the queuing of the radio access bearer.

12. The method of claim 11, wherein the first message confirms that the radio access bearer is being queued.

13. The method of claim 1, wherein the first message further includes a UDP port number of the radio network controller node.

14. A method of operating a radio network controller node comprising:
upon receipt of a request message relating to a procedure for a radio access bearer, queuing the radio access bearer as part of the procedure;
sending from the radio network controller node a first message which includes information regarding the queuing of the radio access bearer and an Internet Protocol (IP) address of the radio network controller node; and then
at least attempting to initialize a user plane; and then
sending from the radio network controller node a second message which indicates an outcome of the procedure.

15. The method of claim 14, wherein the procedure is one of a RAB establish procedure and a RAB modify procedure.

16. The method of claim 14, wherein the request message is a RAB Assignment Request message.

17. The method of claim 14, wherein the request message is a RAB Assignment Request message, and wherein a user plane mode information element in the RAB Assignment Request message specifies a support mode.

18. The method of claim 14, wherein the request message is a RAB Assignment Request message, and wherein the procedure is a RAB modify procedure for a RAB already using a user plane support mode.

19. The method of claim 14, wherein the first message is a RAB Assignment Response message.

20. The method of claim 14, wherein the second message is a RAB Assignment Response message.

21. The method of claim 14, wherein both the first message and the second message are RAB Assignment Response messages having a same format.

22. The method of claim 14, further comprising sending the first message and the second message to a core network node.

23. The method of claim 14, further comprising sending the first message and the second message to a core network node which issued the request message.

24. The method of claim 23, wherein the first message which includes information regarding the queuing of the radio access bearer confirms that the radio access bearer is being queued.

25. The method of claim 14, wherein the first message further includes a UDP port number of the radio network controller node.

26. A radio network controller node having a unit which performs a procedure for a radio access bearer, and wherein in conjunction with receipt of a request message relating to the procedure, the node sends a first message which includes an Internet Protocol (IP) address of the radio network controller node and a second message which indicates an outcome of the procedure.

27. The apparatus of claim 26, wherein the procedure is one of a RAB establish procedure and a RAB modify procedure.

28. The apparatus of claim 26, wherein the request message is a RAB Assignment Request message.

29. The apparatus of claim 26, wherein the request message is a RAB Assignment Request message, and wherein a user plane mode information element in the RAB Assignment Request message specifies a support mode.

30. The apparatus of claim 26, wherein the request message is a RAB Assignment Request message, and wherein the procedure is a RAB modify procedure for a RAB already using a user plane support mode.

31. The apparatus of claim 26, wherein the first message is a RAB Assignment Response message.

32. The apparatus of claim 26, wherein the second message is a RAB Assignment Response message.

33. The apparatus of claim 26, wherein both the first message and the second message are RAB Assignment Response messages having a same format.

34. The apparatus of claim 26, wherein the first message and the second message are sent to a core network node.

35. The apparatus of claim 26, wherein the first message and the second message are sent to a core network node which issued the request message.

36. The apparatus of claim 26, wherein the first message further includes information regarding the queuing of the radio access bearer.

37. The apparatus of claim 36, wherein the first message which includes information regarding the queuing of the radio access bearer confirms that the radio access bearer is being queued.

38. The apparatus of claim 26, wherein the first message further includes a UDP port number of the radio network controller node.

39. A radio network controller node having a unit which performs a procedure for a radio access bearer, and wherein in conjunction with receipt of a request message relating to the procedure, the node performs the steps of:
queuing the radio access bearer as part of the procedure;
sending from the radio network controller node a first message which includes information regarding the queuing of the radio access bearer and an Internet Protocol (IP) address of the radio network controller node; and then
at least attempting to initialize a user plane; and then
sending from the radio network controller node a second message which indicates an outcome of the procedure.

40. The apparatus of claim 39, wherein the procedure is one of a RAB establish procedure and a RAB modify procedure.

41. The apparatus of claim 39, wherein the request message is a RAB Assignment Request message.

42. The apparatus of claim 39, wherein the request message is a RAB Assignment Request message, and wherein a user plane mode information element in the RAB Assignment Request message specifies a support mode.

43. The apparatus of claim 39, wherein the request message is a RAB Assignment Request message, and wherein the procedure is a RAB modify procedure for a RAB already using a user plane support mode.

44. The apparatus of claim 39, wherein the first message is a RAB Assignment Response message.

45. The apparatus of claim 39, wherein the second message is a RAB Assignment Response message.

46. The apparatus of claim 39, wherein both the first message and the second message are RAB Assignment Response messages having a same format.

47. The apparatus of claim 39, wherein the first message and the second message are sent to a core network node.

48. The apparatus of claim 39, wherein the first message and the second message are sent to a core network node which issued the request message.

49. The apparatus of claim 48, wherein the first message which includes information regarding the queuing of the radio access bearer confirms that the radio access bearer is being queued

50. The apparatus of claim 39, wherein the first message further includes a UDP port number of the radio network controller node.
